(19) United States
(12) Patent Application Publication
(10) Pub. No.: US 2026/0175153 A1
(43) Pub. Date: Jun. 25, 2026

(54) FILTER DEVICE AND METHOD FOR MOUNTING SUCH A FILTER DEVICE

(71) Applicant: ATLAS COPCO AIRPOWER, N.V., Wilrijk (BE)

(72) Inventors: Marc STEIJNEN, Wilrijk (BE); Sylwester MANSKI, Wilrijk (BE); Peter WAETERSCHOOT, Kruibeke (BE)

(73) Assignee: ATLAS COPCO AIRPOWER, N.V., Wilrijk (BE)

(21) Appl. No.: 19/354,213

(22) Filed: Oct. 9, 2025

Related U.S. Application Data
(63) Continuation of application No. 19/341,837, filed on Sep. 26, 2025, now abandoned.
Application No. 19/341,837 is a continuation of application No. 15/733,963, now Pat. No. 12,427,466.

(30) Foreign Application Priority Data
Jun. 26, 2018 (BE) 2018/5445

(51) Int. Cl. B01D 46/24; B01D 46/00

(52) U.S. Cl. CPC B01D 46/2411; B01D 46/001; B01D 46/0043; B01D 2201/301

(57) ABSTRACT

A filter element (9) for use in a filter device for the separation of impurities from a gas, the filter device having a pot and a lid, including: a top cap (10) and a bottom cap (11) with a filter cartridge (12) disposed therebetween, wherein the top cap (10) is provided with an inlet duct (17) that will lead gas to be purified to the filter cartridge (12), the inlet duct (17) having an entrance (18) and an outlet (19), and wherein the top cap (2510) includes positioning means (25) configured to position the top cap (10) in relation to the lid of the filter device and pressure means (28) configured to press the entrance (18) of the inlet duct (17) against an inlet of the lid after mounting the pot on the lid (3.

### CROSS REFERENCE TO RELATED APPLICATIONS

This application is a Continuation of U.S. application Ser. No. 19/341,837, filed Sep. 26, 2025, which is a Continuation of U.S. application Ser. No. 15/733,963, filed Dec. 1, 2020, which is a National Stage of International Application No. PCT/IB2019/055137 filed Jun. 19, 2019, claiming priority based on Belgian Patent Application No. 2018/5445 filed Jun. 26, 2018.

### BACKGROUND OF THE INVENTION

### Field of the Invention

The current invention relates to a filter device and method for mounting such a filter device.

More specifically, the invention is intended to filter out impurities such as oil and dust from a gas such as compressed air.

### Background

There are already such filter devices known, which consist of a filter housing in which a filter element can be placed. The filter housing consists of a lid and a pot containing the filter element, whereby the lid is typically screwed onto the pot or connected to the pot via a bayonet fitting.

The lid is provided with an inlet for gas to be purified and an outlet for purified gas.

The filter element itself consists of a top cap and a bottom cap with in between them a filter cartridge consisting of filter material.

The top cap is provided with an inlet duct that will lead gas to be purified to the inside of the filter cartridge. When the filter element is installed, the entrance of the inlet duct is connected to the inlet of the lid, so that the gas to be purified that flows through the inlet of the lid into the filter device is directed to the filter cartridge.

There is a space between the lid and the top cap which is connected to the outlet of the lid, whereby the gas passed through the filter cartridge can leave the filter device via the aforementioned space and the outlet.

It is known that the design of the inlet duct in the top cap will play an important role related to the pressure drop in the filter device.

It is also known that the seal between the inlet of the lid and the entrance of the inlet duct is very important to prevent leaks from the inlet of the lid and the entrance of the inlet duct to the aforementioned space which is connected to the outlet of the lid.

In the known filter devices, this seal is often not 100%, causing leaks and enabling unpurified gas to pass through the filter device.

Traditionally, the lid of the filter device has been built into a pipe, for example, the discharge pipe of a compressor.

When the filter element needs to be replaced, the pot is detached from the lid.

The filter element can then be removed from the lid or from the pot and be replaced.

Then the pot with the filter element is fixed back onto the lid. Hereby, it is very important that the top cap, with the inlet duct, is positioned correctly in relation to the lid, so that the inlet duct is connected to the inlet of the lid.

A disadvantage is that the reinstallation of the pot with the filter cartridge has to be done very accurately, so that this action will take extra time.

An additional disadvantage is that when mistakes are made in this action, for example because the necessary accuracy is not displayed, leaks can occur causing unpurified gas to flow to the outlet of the lid without first passing through the filter cartridge.

The design of the top cap and the lid of the filter device in such a way that the top cap already fits tightly in the lid during mounting in order to ensure a correctly sealed connection of the inlet duct of the top cap to the inlet of the lid after mounting and thus to avoid the aforementioned leaks, causes undesired friction between the top cap and the lid and thus complicates the mounting of the pot on the lid.

This invention aims at solving at least one of the aforementioned and other disadvantages.

### SUMMARY OF THE INVENTION

This invention has a filter device for separating impurities from a gas, whereby the filter device comprises a filter housing consisting of a lid and a pot, whereby a filter element is installed in the pot, which filter element consists of a top cap and a bottom cap with a filter cartridge in between, whereby the lid is provided with an inlet for gas to be purified and an outlet for purified gas, whereby the top cap is provided with an inlet duct that will lead gas to be purified to the filter cartridge, whereby when the pot is mounted on the lid, an entrance of the inlet duct connects to the inlet of the lid and between the lid and the top cap is a space that is connected to the lid outlet, with the characteristic that the filter device is provided on the one hand with positioning means configured to position the top cap in relation to the lid when mounting the pot on the lid, and, on the other hand, with pressure means configured to press the entrance of the inlet duct against the inlet of the lid after mounting the pot on the lid, whereby the positioning means and pressure means are designed in such a way that the positioning means, during mounting of the pot on the lid, take effect earlier than the pressure means.

An advantage is that the positioning means will ensure that the top cap is correctly positioned in relation to the lid, so that the inlet of the lid is aligned with the inlet duct.

This will ensure that the gas to be purified is correctly guided into the filter element.

Another advantage is that leaks can be avoided by pressing the seal between the entrance of the inlet duct and the inlet of the lid.

As the pressure means during the mounting of the pot on the lid only take effect later than the positioning means, friction between the top cap and the lid, which occurs during mounting when connecting the top cap and the lid, is reduced or avoided. Only after the correct alignment of the entrance of the inlet duct with the inlet of the lid has been almost or fully achieved, the entrance will be pressed towards the inlet, which will allow a good and easy mounting of the pot on the lid.

Preferably, the entrance of the inlet duct or the inlet of the lid is provided with a non-removable seal.

By providing a non-removable seal, it is possible to prevent the seal from loosening or shifting during the mounting of the lid on the pot. This provides extra security against poor sealing.

The invention also has a method for mounting a filter device for the separation of impurities from a gas as subject, whereby the filter device includes a filter housing consisting of a lid and a pot, whereby a filter element is installed in the pot, which filter element consists of a top cap and a bottom cap with a filter cartridge in between, whereby the lid is provided with an inlet for gas to be purified and an outlet for purified gas, whereby the top cap is provided with an inlet duct that will lead gas to be purified to the filter cartridge, whereby, when the pot is mounted on the lid, the entrance of the inlet duct connects to the inlet of the lid and between the lid and the top cap there is a space which is connected to the outlet of the lid, with the characteristic that the filter device on the one hand is provided with positioning means which will position the top cap in relation to the lid during the mounting of the pot on the lid, and on the other hand with pressure means which will press the entrance of the inlet duct against the inlet of the lid after the mounting of the pot on the lid, whereby during the mounting of the pot on the lid the positioning means take effect earlier than the pressure means.

### BRIEF DESCRIPTION OF THE DRAWINGS

With the insight to better demonstrate the characteristics of the invention, the following describes, as an example without any restrictive character, some preferred embodiments of a filter device according to the invention, with reference to the accompanying drawings, in which:

FIG. 1 schematically and in perspective shows a filter device according to the invention;

FIG. 2 shows a cross-section according to line II-II in FIG. 1;

FIG. 3 shows in more detail the part indicated by F3 in FIG. 2;

FIG. 4 schematically and in perspective represents the top cap of FIGS. 2 and 3;

FIG. 5 shows the bottom of the lid in more detail;

FIG. 6 shows a different view of the top cap in FIG. 4.

### DETAILED DESCRIPTION OF THE INVENTION

FIG. 1 shows a filter device 1 according to the invention to separate impurities from a gas.

This gas may be compressed air, but the invention is not limited thereto.

The aforementioned impurities can be oil, water and/or dust.

The filter device 1 contains a filter housing 2, which consists of a lid 3 and a pot 4, which can be mounted on top of each other to form the filter housing 2.

In the example shown, the lid 3 is screwed onto the pot 4, whereby both the lid 3 and the pot 4 are provided with a cooperating screw thread 5.

It is not excluded that the lid 3 is fixed to the pot 4 by means of a bayonet fitting or some other way.

The lid 3 is provided with an inlet 6 for gas to be purified and an outlet 7 for purified gas. Typically, the filter device 1 with its lid 3 is mounted in a pipe of a machine, such as a compressor installation. For this purpose, the lid 3 at the inlet 6 and the outlet 7 are provided with flanges 8 suitable thereto.

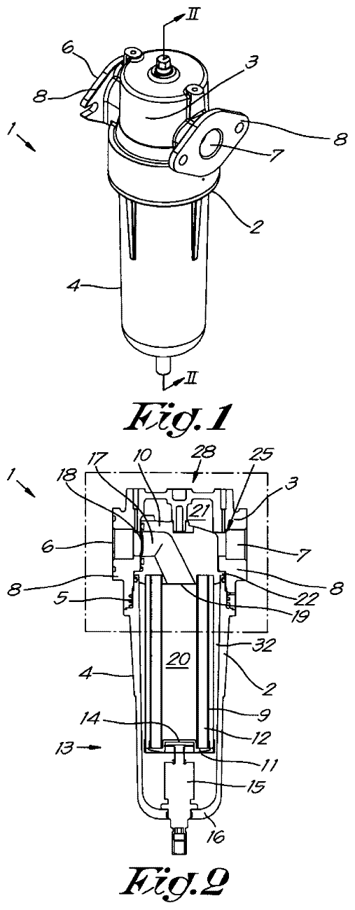

In the filter housing 2, more specifically in the pot 4, a filter element 9 is installed. This is shown in FIG. 2, which shows a cross-section.

The filter element 9 consists of a top cap 10 and a bottom cap 11 with a filter cartridge 12 between them, which is made of filter material.

The bottom cap 11 is optionally provided with means 13 to translationally position and/or fix the filter element 9 in the pot 4 in each direction after mounting of the pot 4 in the lid 3. This means that the means 13 limit or forbid a translational shift of the filter element 9 compared to the pot 4 in any direction, but allow an unlimited rotational movement of the filter element 9 relative to the pot 4.

These means 13 are implemented as a cavity 14 or recess that can work together with a thereto provided rod 15 in the bottom 16 of the pot 4.

In addition, these means 13 are designed in such a way that the filter element 9 can be rotated in the pot 4. This means that it is possible that the filter element 9 rotates around its axis in the pot 4.

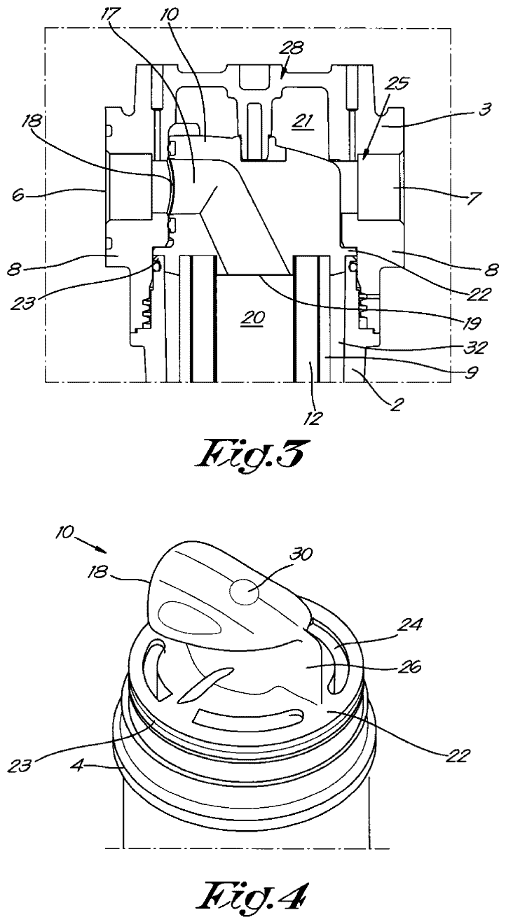

The detailed FIG. 3 clearly shows how the top cap 10 is made.

The top cap 10 is provided with an inlet duct 17 that will lead gas to be purified to the filter cartridge 12.

The inlet duct 17 has an entrance 18 which, when the pot 4 is mounted on the lid 3, connects to the aforementioned inlet 6 of the lid 3. The inlet duct 17 also has an outlet 19 that connects to the interior 20 of the filter cartridge 12.

As one can clearly see in FIG. 3, there is a space 21 between the lid 3 and the top cap 10 that is connected to the outlet 7 of the lid 3.

In this case, but not necessary for the invention, the top cap 10 has an extending collar 22 or flange which can rest on the upper edge 23 of the pot 4. This will help to position the filter element 9 in the pot 4.

This collar 22 or flange extends over the entire circumference of the upper edge 23 and is provided with at least one passage 24 through the collar. It is also possible that the collar 22 extends only over a part of the circumference of the upper edge 23 or that there are interruptions in the collar 22.

According to the invention, the filter device 1 is provided with positioning means 25 that will position the top cap 10 relative to the lid 3 when mounting the pot 4 on the lid 3.

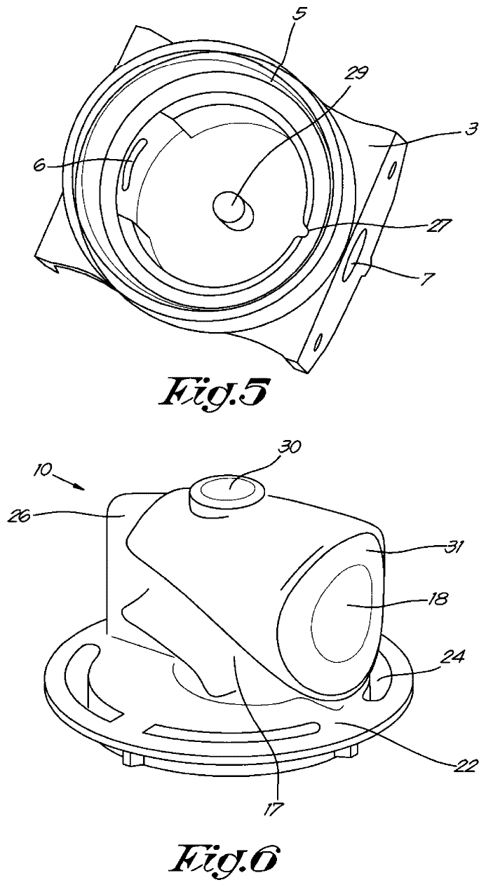

In the example shown in FIGS. 4 and 5, these positioning means 25 are executed in the form of, on the one hand, a positioning fin 26 on the top cap 10 and, on the other hand, a positioning recess 27 in the lid 3, whereby the positioning fin 26 of the top cap 10 fits in the positioning recess 27 of the lid 3.

It is clear that it is also possible that the top cap 10 is provided with the positioning recess 27 and the lid 3 of the positioning fin 26 that fits in the positioning recess 27.

Only when the positioning fin 26 is inserted or pushed into the positioning recess 27 in the lid 3, the top cap 10 in the lid 3 will fit.

According to the invention, the filter device 1 is further provided with pressure means 28 which will press the entrance 18 of the inlet duct 17 against the inlet 6 of the lid 3 after mounting the pot 4 on the lid 3.

In the example shown in FIGS. 4 and 5, these pressure means 28 are made in the form of a pin 29 in the lid 3 and a corresponding cavity 30 in the top cap 10.

It is clear that it is also possible that the lid 3 is provided with a cavity 30 and the top cap 10 is provided with a pin 29.

As a result, the distance between the cavity 30 and the inlet 6 of the lid 3 is determined by the distance from the pin 29 to the inlet 6.

By correctly selecting the distance between the pin 29 and the inlet 6, it will be possible to ensure that the entrance 18 of inlet duct 17 is pressed against inlet 6.

As can be seen on FIGS. 3 to 5, the positioning means 25 will take effect earlier than the pressure means 28. Indeed, when inserting the top cap 10 into the lid 3, the positioning fin 26 must be pushed first into the positioning recess 27, before the top cap 10 can be inserted further into the lid 3. Only when the top cap 10 has been inserted further into the lid 3, the pin 29 will enter the cavity 30 and exert pressure.

Finally, a non-removable seal 31 is provided between the inlet 6 of the lid 3 and the entrance 18 of the inlet duct 17 of the top cap 10.

In a practical version of the invention, the non-removable seal is provided at the entrance 18 of the inlet duct 17.

Preferably, this is poured on the entrance 18, so that it is part of the top cap 10. The seal 31 is preferably made of a thermoplastic elastomer.

It cannot be excluded, however, that the non-removable seal 31 is provided on the inlet 6 of the lid 3 on a side of the lid 3 which is closest to the entrance 18 of the inlet duct 17 of the top cap 10.

However, since the filter element 9 will be replaced from time to time, it is preferable to provide the seal 31 on the top cap 10, so that it can be replaced as well. In this case, the material of the seal 31 must be selected in such a way that the seal 31 can be used continuously for a period of time at least equal to the period between two replacements of the filter element 9, as it is not desirable that the e seal 31 should be replaced between two replacements of the filter element 9.

To protect the seal 31 from damage, the inlet 6 of the lid 3 on a side closest to the inlet duct 17 of the top cap 10 when the pot is mounted on the lid, may be rounded or chamfered. This chamfer may, for example, be a straight chamfer of the edge between the inlet 6 and a side of the lid 3 which, when mounted, is closest to the inlet duct 17 of the top cap 10, the straight chamfer being at an angle between 5° and 45° with the side of the lid 3 which is closest to the inlet duct 17 of the top cap 10.

The operation of the filter device 1 is very simple and as follows.

Gas to be purified enters the filter device 1 through the inlet 6 in the lid 3 and then goes through the entrance 18 and the inlet duct 17 of the top cap 10 to the filter cartridge 12.

The outlet 19 of the inlet duct 17 connects to the interior 20 of the filter cartridge 12, so that the gas to be purified will flow through the filter cartridge 12 from the inside to the outside, whereby impurities are removed from the gas when passing through.

The purified gas then enters the zone 32 between the filter cartridge 12 and the pot 4, from where it enters the space 21 between the top cap 10 and the lid 3 via the passages 24 in the collar 22 of the top cap 10.

The purified gas can then leave the filter device 1 via the outlet 7 in the lid 3.

When the filter cartridge 12 is saturated with impurities, it must be replaced.

For this purpose, the pot 4 is unscrewed from the lid 3, as the latter is often fixed in a machine or the like.

It should be noted that the filter element 9 will not move rotationally in relation to the lid 3 but in relation to the pot 4.

When the pot 4 is removed, the filter element 9 can be removed.

A new filter element 9 can then be installed. This new filter element 9 is installed in the pot 4, whereby it is optionally ensured that the rod 15 ends up in the cavity 14 of the bottom cap 11.

Next, the pot 4 is placed under and against the lid 3 and the pot 4 is turned until the positioning fin 26 of the top cap 10 ends up in the positioning recess 27 of the lid 3.

At that moment the top cap 10 will be correctly positioned in relation to the lid 3, so that after screwing on the pot 4 the entrance 18 corresponds to the inlet 6.

In addition, at the same time the top cap 10 can be pushed further into the lid 3 and at the same time the pot 4 can be screwed further into the lid 3. This means that only when the top cap 10 is correctly positioned in relation to the lid 3, the pot 4 can be screwed on.

During screwing the filter element 9 will not rotate with the pot 4.

At a certain moment, when the pot 4 is screwed on far enough, pin 29 will also fit in the cavity 30 and thus push the entrance 18 against the inlet 6.

This ensures a good seal between the entrance 18 and the inlet 6 and no leakage flow can occur.

Despite the fact that in the examples described above, a gas flow from the inlet 6 to the inlet duct 17 and the interior 20 of the filter cartridge 12 runs through the filter cartridge 12 and through the passages 24 in the collar 22 to the space 21 and outlet 7 in the lid 3, it cannot be ruled out that the gas flow may flow in the other direction. That is to say, the gas enters through the outlet 7 in the lid 3, goes through the space 21 through the passages 24 in the collar 22 and then through the filter cartridge 12 and then through the inlet duct 17 to the inlet 6 in the lid 3 to leave the filter device 1.

This invention is by no means limited to the embodiments described as examples and shown in the figures, but a filter device according to the invention can be realised in all shapes and sizes without going beyond the scope of the invention.

1. A filter element (9) for use in a filter device for the separation of impurities from a gas, the filter device including a pot and a lid, comprising:
a top cap (10) and a bottom cap (11) with a filter cartridge (12) disposed therebetween,
wherein the top cap (10) is provided with an inlet duct (17) that will lead gas to be purified to the filter cartridge (12), the inlet duct (17) having an entrance (18) and an outlet (19), and
wherein the top cap (2510) includes positioning means (25) configured to position the top cap (10) in relation to the lid of the filter device and pressure means (28) configured to press the entrance (18) of the inlet duct (17) against an inlet of the lid after mounting the pot on the lid (3).

2. The filter element according to claim 1, wherein the positioning means (25) and the pressure means (28) are configured such that the positioning means (25) come into action with the filter device earlier than the pressure means (28) during the mounting of the pot (4) on the lid (3).

3. The filter element according to claim 2, wherein the positioning means (25) includes a positioning member (26) on the top cap (10) for rotationally fixing the top cap (10) relative to the lid.

4. The filter element according to claim 3, wherein the positioning member (26) is a positioning fin.

5. The filter element according to claim 2, wherein the pressure means (28) includes a pin (29) on the top cap (10).

6. The filter element of claim 2, wherein the inlet duct (17) includes a seal (31) provided around the entrance.

7. The filter element of claim 6, wherein the seal (31) is an integral part of the top cap (10).

8. The filter element of claim 7, wherein the seal (31) is made out of a thermoplastic elastomer.

9. The filter element of claim 1, wherein the top cap (10) is provided with an extending collar (22) around a periphery thereof configured to rest on an upper edge of the pot.

10. The filter element of claim 8, wherein the collar (22) extends over the entire circumference of the upper edge and at least one passage (24) is provided in the collar.

11. The filter element according to claim 1, wherein the bottom cap (11) includes means for translationally positioning the filter element in relation to the pot.
